(19) United States
(12) Patent Application Publication
(10) Pub. No.: US 2006/0215185 A1
(43) Pub. Date: Sep. 28, 2006

(54) Structuring a staggered job termination pattern

(75) Inventor: Robertus C.W.T.M. Van Den Tillaart, Gemert (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 11/387,844

(22) Filed: Mar. 24, 2006

(30) Foreign Application Priority Data
Mar. 25, 2005 (EP) 05102432.1

(51) Int. Cl. G06F 3/12

(52) U.S. Cl. 358/1.1

(57) ABSTRACT

A method and apparatus executes a printing job on a plurality of printer facilities by dividing the printing job into partial jobs and selectively assigning each partial job to a respective printer facility. The assigning of the partial jobs to the printer facilities attains an improved throughput for the printing job. The method structures a job termination pattern by assigning a partial job to a particular printer facility that will complete earlier than a partial job assigned to another printer facility by a time difference based on a predetermined non-zero time interval. Such a time interval may be defined by an operator in advance. All printer facilities involved in a printing job may be assigned respective partial jobs so that their sequence of completion time instants, in compliance with the user-selected time interval, will constitute a monotonously non-decreasing series.

### CROSS-REFERENCE TO RELATED APPLICATIONS

This nonprovisional application claims priority under 35 U.S.C. § 119(a) on Patent Application No. 05102432.1, filed in Europe on Mar. 25, 2005, the entirety of which is incorporated herein by reference.

### BACKGROUND OF THE INVENTION

1. Field of the Invention

The present invention relates to a method for executing a printing job on a plurality of printer facilities including dividing the printing job into partial jobs and selectively assigning each partial job to a respective printer facility for attaining an improved throughput for the printing job.

In addition, with regard to printing from input data, the present invention similarly relates to copying, where the original is presented as a physical product, usually on paper. Hereinafter, such copying is likewise referred to as “printing” for reasons of brevity.

2. Description of Background Art

Generally, the dividing of a big and distributable load over a plurality of execution facilities is a well-known solution. This approach is also known in the printing art for distributing large print jobs over several printer facilities. Generally, the load is distributed in such manner that all facilities will complete at substantially the same instant, as is, for instance, disclosed in UK Patent Application No. 2368954.

The present inventor has however recognized a shortfall of this solution. For example, completion of a partial job often necessitates some personal attention or “service” by an operator, such as removing the printing result, manual feeding to a finishing station, etc. If all printer facilities terminate at substantially the same instant, the operator will have to keep some of the facilities waiting. A similar problem can result when a machine system for product handling can only service less than all printer facilities concurrently.

### SUMMARY OF THE INVENTION

In consequence, amongst other things, it is an object of the present invention to further improve the throughput of a plurality of printer facilities for a distributable printing job.

According to a first aspect of the present invention, a method for executing a printing job on a plurality of printer facilities comprises the steps of:

dividing the printing job into partial jobs;

selectively assigning each of the partial jobs to a respective printer facility for attaining an improved throughput for the printing job; and

structuring a job termination pattern by assigning a partial job to a particular printer facility of said plurality of printer facilities that will complete earlier than a partial job assigned to another printer facility of said plurality of printer facilities by a time difference based on a predetermined non-zero time interval.

Basically, an embodiment of the present invention involves having the various partial printing jobs terminate at staggered instants for allowing particular attention or service operation during such staggered intervals. In particular, an embodiment of the present invention often involves deliberately scheduling certain partial jobs to finish later, to thereby produce the final result at an earlier instant. Staggering such terminations in time would improve throughput in various instances, without requiring extra effort from the operator. Another advantage of the present invention is that certain printer facilities will often become available for other work at relatively earlier instants in time.

The time difference between the completion instants of any two partial jobs may be predetermined as a system default, possibly programmed by a system engineer at installation, but it may also be user-selectable, e.g. through a user interface, in order to give the operator of the printers the opportunity to tune the job processing to his activities. The system then calculates a division of the printing jobs into partial jobs. The division of the printing jobs is based on the time differences specified by the operator. In particular, the printing job is preferably divided at existing divisions within the job, e.g., between copies when a job contains a plurality of copies. Such a division makes it easier for the operator to put the printed copies of the job together without errors.

The time differences between partial job completions as calculated by the system are preferably at least as long as a time interval actually entered by the operator through the user interface. However, the composition of the printing job may not always allow a division that has completion time differences that exactly conform to the operator's wishes. In that case, the division is preferably made such that at least most of the partial jobs have completion times that are at least apart by the time interval as defined by the operator.

Of course, printing jobs may also be divided on another division level, such as sub-sets or even print sheets.

Advantageously, the above method is applied on a set of printers having mutually disparate throughput speeds by assigning the last partial job termination instant to the printer facility with the fastest throughput. This will effectively raise overall throughput by delaying the termination instant of the fastest printer facility.

In an embodiment of the present invention, a dividing and assigning process that is based on temporal availability of the various printer facilities is also provided. Thus, a printer that is occupied by another printing job may still be involved, even though it may become available later than the start of the present job. Since the printers are all centrally managed, their job completion times are known to the system and can be used in the scheduling process.

The present invention also relates to an apparatus that is arranged for implementing the above-described method. Specifically, an apparatus for controlling execution of a printing job on a plurality of printer facilities for attaining an improved throughput for the printing job comprises:

a job scheduler for dividing the printing job into partial jobs and for selectively assigning each of the partial jobs to a respective printer facility,

wherein said job scheduler is arranged for structuring a job termination pattern by assigning a partial job to a particular printer facility of said plurality of printer facilities that will complete earlier than a partial job assigned to another printer facility of said plurality of printer facilities by a time difference based on a predetermined non-zero time interval.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a printer arrangement with three printers;

FIG. 2 is a first printing assignment pattern;

FIG. 3 is a second printing assignment pattern;

FIG. 4 is a third printing assignment pattern;

FIG. 5 is a sample flowchart for use with the invention; and

FIG. 6 is a sample graphical user interface for the print job scheduler.

### DETAILED DESCRIPTION OF THE PREFERRED EMBODIMENTS

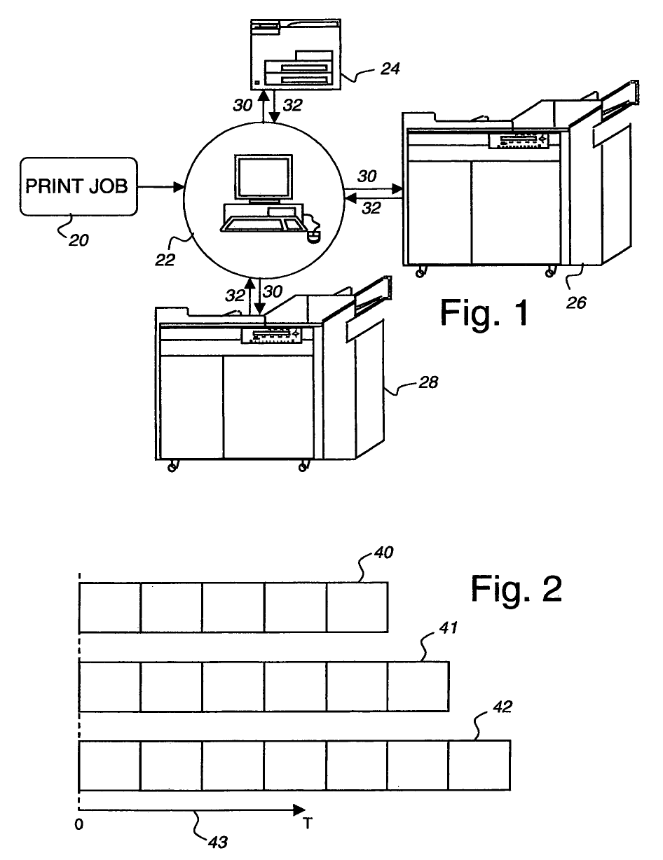

The present invention will now be described with reference to the accompanying drawings. FIG. 1 illustrates a block diagram of a printer arrangement with three printers. At the left in FIG. 1, block 20 symbolizes a printing job that must be executed by the three printers 24, 26, 28 at the right in FIG. 1. The printers may be of any kind and do not have to be the same. The job is routed to print job scheduler 22, that may be implemented in a PC. The print job scheduler 22 divides the printing job into partial jobs, preferably along existing divisions, such as copies, when the printing job specifies several copies to be made of one digital document. Division may also be made at page level, especially when the printing job is a single copy of a digital document. Furthermore, the print job scheduler 22 assigns the partial jobs to the various printers. Commands thereto are routed along arrows 30, whereas return-signalizations are routed along lines 32. Preferably, all connections are implemented by a digital network, such as a local area network, a wide area network or the Internet, a corporate intranet, or the like.

Commands would include starting instants, number of sets to be printed, job identifiers, and the like. Return-signalizations would include O.K, partial job ready, number of sets yet to be done, printing interrupts such as paper out or jamming, etc. By itself, persons skilled in the art would know to design schedulers, given the requirements as specified.

The algorithm used by the scheduler could be logical, wherein a set of equations is evaluated through inserting various parameters. The result thereof is the assignment of the various partial jobs to the various printers. Another preferred solution is by heuristics, wherein one or more tentative assignments are evaluated, and the best thereof is selected for effecting the assignment. If necessary, still further tentative assignments may be tried.

FIG. 2 illustrates a first printing assignment pattern. Each block represents one printing set or copy on a time scale (T) as represented by arrow 43. All partial jobs 40, 41, 42 start concurrently at left, at T=0. The three printers collectively execute a printing job of 18 sets, distributed into groups of 5, 6 and 7 sets, respectively. At the right in FIG. 2, the partial jobs have staggered termination instants. If the operator's effort at terminating a partial job equals the length of one block, the whole job will be finished after 8 block lengths. If all blocks would terminate at the same instant, the whole job will be finished after 6 (printing)+3 (operator activity)=9 block lengths. Thus, using the present invention, the same amount of work is done in less time. Furthermore, the usage ratio of the printers could be raised as well. If a printer can be made to restart immediately after the operator service terminates, idle time would represent only 3 blocks, and the usage ratio would be 18/21=86%. If the partial jobs have the same size, all blocks would terminate at the same instant, idle would represent 1+2+3=6 blocks, and the usage ratio would decline to 18/24=75%.

If the operator activity takes more time, such as 1½ blocks, the improvement would be even greater. If the operator activity takes less time, the improvement would be less. In the case of only a ½ block length user time, both schemes have equal overall ready delay. Nevertheless, the printer use ratio for the present invention would still be better. Of course, when only brief operator activity is required, a smaller staggering size could also be used, if feasible. If the required post-processing time were zero, the outcome of the algorithm would be all printers terminating at the same instant, as in the above-mentioned UK Patent.

The present invention can also be applied when a plurality of operators is present. The logic-based algorithm would then tend to be more complex, but still straightforward. The same applies if the post-processing time is a function of the size of the partial job, is non-uniform for the various operators, for the various partial facilities, or in the course of time. An example of the latter would be that during absence of the operator, such as during lunch time, post-service may be stalled, so that it would be advantageous to have as many printers as possible running through the whole of this absence. For such purposes, the period of non-availability would advantageously be made known to the scheduler, such as through a user interface.

Even in cases wherein the number of divisions (sets) is not such that neatly staggered partial jobs can be formed, such that, e.g., two out of a plurality of three printers are assigned the same number of sets, there would still be some gain in total processing time and machine usage ratio.

FIG. 3 illustrates a second printing assignment pattern to show the improvement when the staggering of the partial jobs 44, 45 is by two blocks, and where operator activity 46 requires a 5/4 block length of time. In this case, the operator has to wait a brief interval after the first partial job has been taken care of.

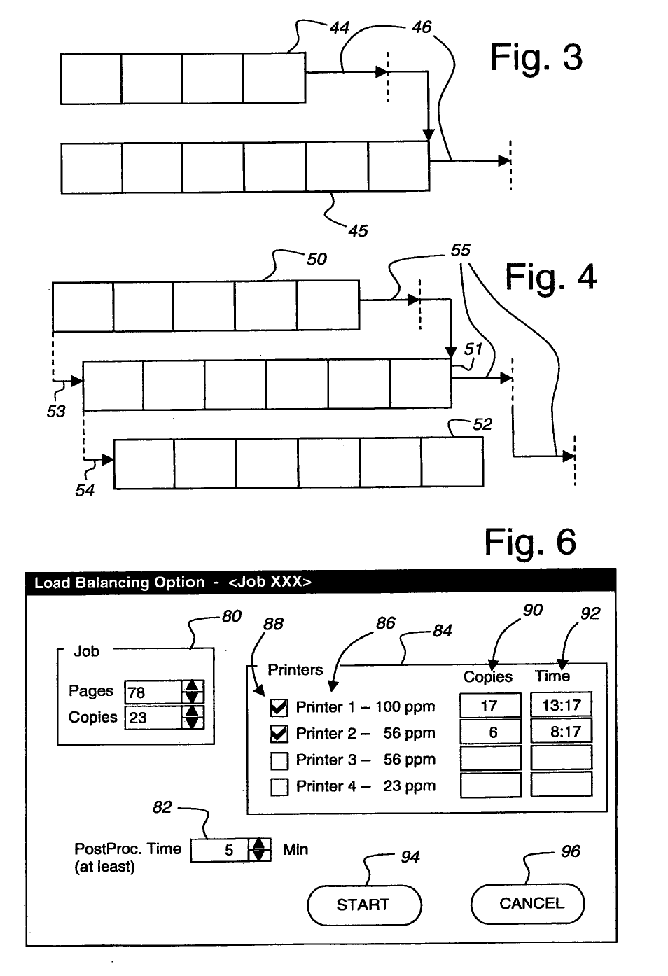

FIG. 4 illustrates a third printing assignment pattern. This case applies in situations where the printing job necessitates some initial effort by the operator before starting the partial jobs, such as loading of special print sheets or pre-printed inserts in the paper input trays of the devices. In this situation, the starting instants of the partial jobs 50, 51, 52 are also staggered by operator activity time intervals 53, 54. The dashed lines indicate operator readiness. The arrows indicate the sequence of the operator's actions. If the operator needs 1 (one) block length of time 55 for post-processing as shown, the operator also has to wait a brief interval after the first partial job has been taken care of.

In the above examples, jobs are split into partial jobs on a set level, i.e., presuming a printing job contains a plurality of sets, sets are not broken by the division and each partial job contains an integer number of sets. Obviously, jobs may also be split on a lower level, such as print sheets. For jobs having a single set, such a division is the only one possible. However, multi-set jobs may also be split on a sheet level, although extra care of the operator is required to correctly consolidate the partial job outputs.

A further example of the above heuristic algorithm for calculating the “estimated time ready” accounts for present activity on earlier jobs will be described. With three printers, P1 and P2 idle, but P3 still having to work for 10 minutes on a previous job (plus five minutes post-processing), a 60 minute job will be assigned as follows, while ignoring granularity effects.

P1: 20 minutes partial job plus five minutes post-processing, ready after 25 minutes.

P2: 25 minutes partial job plus five minutes post-processing, ready after 30 minutes.

P3: 15 minutes previous job (inclusive post-processing), furthermore 15 minutes next partial job plus five minutes post-processing, ready after 35 minutes.

A further example has an 18 minute job and a 2½ minute post-processing on each of three printers. Two feasible solutions are as follows.

According to a first solution, the printers are assigned 4, 6 and 8 minutes of printing, respectively. Then, ready times are:

P1: 4+2½=6½

P2: 6½+2½=9 (note: having to wait for ½ minute before post-processing can start)

P3: 9+2½=11½.

According to the second solution, the printers are assigned 3, 6 and 9 minutes of printing, respectively. Then, ready times are:

P1: 3+2½=5½

P2: 6+2½=8½

P3: 9+2½=11½.

The second solution is more robust, inasmuch as each post-processing interval may now run out by ½ minute before an overall delay will be experienced.

The following is an example for only two printers, a ten minute job and a 2½ minute post-processing.

As a first solution, both printers are assigned 5 minutes of the job. Then, ready times are as follows:

P1: 5+2½=7½

P2: 7½+2½=10.

As a second solution, the first printer is assigned 4 minutes of the job and the second printer is assigned 6 minutes of the job. Then, ready times are as follows:

P1: 4+2½=6½

P2: 6½+2½=9.

Finally, in a third solution, the first the printer is assigned 3 minutes of the job and the second printer is assigned 7 minutes of the job. Then, ready times are as follows:

P1: 3+2½=5½

P2: 7+2½=9½.

Clearly, the second assignment schedule delivers the fastest job completion.

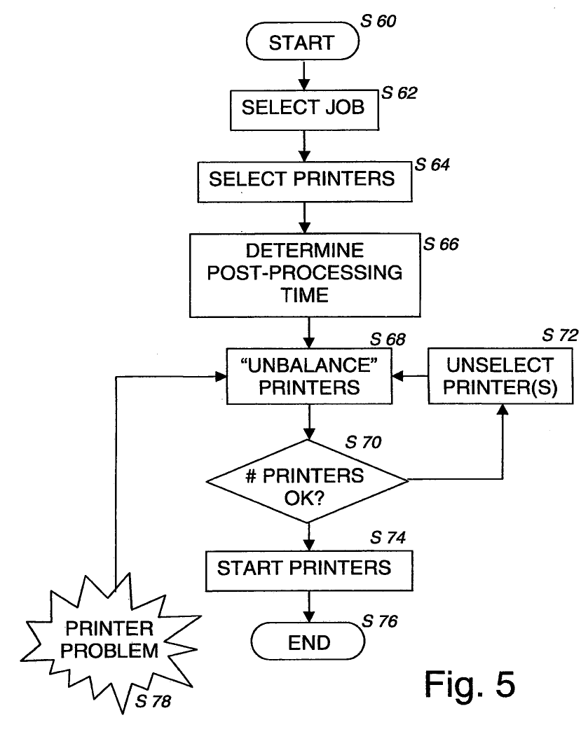

FIG. 5 illustrates a sample flowchart of an assignment process for use with an embodiment of the present invention. In block S 60, the execution starts, and hardware and software facilities are assigned as far as relevant. In block S 62, the job or jobs are selected from a task schedule. In block S 64, available printers are selected. In block S 66, the various post-processing times are determined, such as by looking up in a look-up table or by operator entry at the user interface of the job scheduler 22. In block S 68, the print job is split into partial jobs, which are then assigned through executing the process of the present invention. In block S 70, the system checks if the number of printers that have been assigned to the job in question is not too large. For example, a relatively small job must not be processed on too many printers, because each separate printer would need its own post-processing, that could in fact extend overall processing. If the answer is positive in block S 70, one or more printers are unselected in block S 72. The system then reverts to block S 68 for a new division and assigning trial. If the printers have been properly “unbalanced” in block S 68 according to the present invention, the printers are started in block S 74. In block S 76, the assigning procedure terminates. If a particular printer has to stop before fulfilling its task, as is schematically represented in item S 78, the process of FIG. 5 may be entered at another point, for example, immediately at block S 68.

It should be noted that various simplifications have been used in FIG. 5. For example, no user dialog has been shown.

FIG. 6 illustrates a sample graphical user interface for the print job scheduler 22 shown in FIG. 1. In the first place (but not shown for clarity), a job queue may be displayed on the display screen of the job scheduler 22. A particular job may be selected by the operator or automatically, and subsequently, various processing options may be chosen. One of these is load unbalancing, which opens the window as shown in FIG. 6. Field 80 shows job details, such as the number of pages of the digital document to be printed and the number of copies to be made in total. If necessary, such as for a copying job, the operator must specify these quantities. In a more sophisticated embodiment, the operator must only specify the number of copies, while the number of pages is automatically determined upon scanning. In the latter case, the scheduler waits to calculate the assignment scheme until the number of sheets has been determined.

Field 82 indicates a post-processing time for the operator that may be a default value ready to be adjusted by operator entry. It should be noted that the post-processing time entered in field 82 is taken as a minimum post-processing time in the assignment calculation, since it may not be possible in many cases, and it may not be necessary, to calculate a scheme that precisely produces the entered value.

The area 84 is used for the actual job division and assignment, showing a list 86 of all available printers, each preceded by a check box (88) for the operator to indicate an intended involvement of a respective printer in the printing job. It may be noted that the various printers are listed to have different printing speeds, such as “Printer 1” having a speed of 100 prints per minute.

Upon checking one or more printers through the check boxes 88, the scheduler 22 will automatically calculate the optimum assignment according to the algorithm described in FIG. 5, and show the actual assignment. In this case, printers # 1 and # 2 with different capabilities will do the work. Also, the number of copies (field 90) and the expected finishing time (field 92) are shown, so that the operator will know when to be present. If necessary, finishing will be signalled by an audio signal. Thereupon, the start button 94 may be actuated. For various purposes, a cancel button 96 is shown as well. Note that the user interface may contain various (other) high-level facilities.

Although not shown in FIG. 6, the user interface may also include a field for the operator to enter certain periods of operator non-availability, e.g. a lunch break. The scheduler may then take such periods into account by avoiding partial jobs to end in those periods.

Various other aspects of the present invention may also play a part:

1. The time difference between print job endings may also be automatically determined by the scheduler 22 on the basis of the job data and the job division scheme (possibly in an iterative process). For instance, in case of the print job being divided into large partial jobs that need careful handling, the scheduler may automatically assign time differences that are relatively large. However, when the partial jobs are small, the time differences may be made smaller, since the operator may need less time to handle them.

2. Not all printers need to be identical. If local throughput of a particular printer is different, only the termination instants scheduling needs to be considered for the assigning. Note that assigning the partial job that will end last to the fastest printer will speed-up overall throughput since this printer is most productive (cf. FIG. 6, wherein Printer 2, the slowest one, is scheduled to finish after 8:17 minutes, whereas Printer 1, which is faster, runs 13:17 minutes). More generally, in case of several printers all having different throughputs, the termination instants would be ordered in a series accordingloy, with the fastest printer ending last and the slowest printer ending first.

3. Upon unforeseen stopping of a particular printer, the scheduling for the other printers may be re-calculated in a dynamic manner for again attaining the best result. The converse applies when a particular printer comes up again after such interrupt, or when an additional printer is added to the pool.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for executing a printing job on a plurality of printer facilities, said method comprising the steps of:
dividing the printing job into partial jobs;
selectively assigning each of the partial jobs to a respective printer facility for attaining an improved throughput for the printing job; and
structuring a job termination pattern by assigning a partial job to a particular printer facility of said plurality of printer facilities that will complete earlier than a partial job assigned to another printer facility of said plurality of printer facilities by a time difference based on a predetermined non-zero time interval.

2. The method as claimed in claim 1, further comprising the step of enabling an operator to define the predetermined time interval.

3. The method as claimed in claim 1, further comprising the step of arranging the dividing and assigning steps so as to structure a job termination pattern, based on said predetermined time interval, forming a sequence of partial job completion time instants constituting a monotonously increasing series.

4. The method as claimed in claim 3, further comprising the step of arranging the dividing and assigning steps so as to structure a job termination pattern having time differences between job completion time instants that are each at least as long as the predetermined time interval.

5. The method as claimed in claim 3, further comprising the step of arranging the dividing and assigning steps so as to structure a job termination pattern having time differences between job completion time instants, most of the time differences being at least as long as the predetermined time interval.

6. The method as claimed in claim 4, wherein said time differences are substantially equal.

7. The method as claimed in claim 1, wherein said partial jobs differ by an integer number of print copies within said printing job.

8. The method as claimed in claim 1, wherein said partial jobs differ on a lower level of granularity than print copies within said printing job.

9. The method as claimed in claim 8, wherein the lower level of granularity is a level of sub-sets or print sheets.

10. The method as claimed in claim 1, wherein said plurality of printer facilities includes printer facilities having mutually disparate throughput speeds, wherein the dividing and assigning steps are based on the throughput speeds of the various printer facilities.

11. The method as claimed in claim 10, further comprising the step of assigning the last partial job termination instant to the printer facility with the highest throughput speed.

12. The method as claimed in claim 1, wherein the dividing and assigning steps are based on temporal availability of the various printer facilities.

13. The method as claimed in claim 1, wherein the dividing and assigning steps comprise the step of assigning non-uniform partial job starting time instants to the various printer facilities.

14. An apparatus for controlling execution of a printing job on a plurality of printer facilities for attaining an improved throughput for said printing job, comprising:
a job scheduler for dividing the printing job into partial jobs and for selectively assigning each of the partial jobs to a respective printer facility,
wherein said job scheduler is arranged for structuring a job termination pattern by assigning a partial job to a particular printer facility of said plurality of printer facilities that will complete earlier than a partial job assigned to another printer facility of said plurality of printer facilities by a time difference based on a predetermined non-zero time interval.

15. The apparatus as claimed in claim 14, further comprising a user interface for entering control parameters that is adapted to enable an operator to define the predetermined time interval.

16. The apparatus as claimed in claim 14, wherein said job scheduler is arranged for structuring a job termination pattern, based on the predetermined time interval, forming a sequence of partial job completion time instants constituting a monotonously increasing series.

17. The apparatus as claimed in claim 15, wherein said job scheduler is arranged for structuring a job termination pattern, based on the predetermined time interval, forming a sequence of partial job completion time instants constituting a monotonously increasing series.

18. The apparatus as claimed in claim 14, wherein said job scheduler is arranged for dividing a printing job on a level of copies of the printing job.

19. The apparatus as claimed in claim 14, wherein said job scheduler is arranged for dividing a printing job on a lower level of granularity than print copies within said printing job.

20. The apparatus as claimed in claim 19, wherein the lower lever of granularity is a level of sub-sets or print sheets.
